(19) United States
(12) Patent Application Publication
(10) Pub. No.: US 2025/0315441 A1
(43) Pub. Date: Oct. 9, 2025

(54) SYSTEMS AND METHODS FOR CORRELATING RESPONSES TO USER-SPECIFIC DATA

(71) Applicant: Capital One Services, LLC, McLean, VA (US)

(72) Inventors: Paul LY, Wylie, TX (US); Will IBEKWE, Dallas, TX (US); Allen JUNG, Carrollton, TX (US)

(73) Assignee: Capital One Services, LLC, McLean, VA (US)

(21) Appl. No.: 19/197,309

(22) Filed: May 2, 2025

Related U.S. Application Data
(63) Continuation of application No. 18/630,281, filed on Apr. 9, 2024.

(51) Int. Cl. G06F 16/2457; G06F 16/248; G06F 16/28

(52) U.S. Cl. CPC G06F 16/24578; G06F 16/248; G06F 16/285

(57) ABSTRACT

A technique for correlating responses to user-specific data may include obtaining user-specific data having an item parameter and an interaction parameter set by the user; generating a user-specific score based on prequalification and interaction data; generating a classification of the user based on the score; identifying entities providing an item corresponding to the parameter; transmitting at least a portion of the user-specific data and the classification of the user to the plurality of entities; receiving responses from the plurality of entities, each response including parameters for a proposed interaction with the user in which at least one parameter is responsive to the user-specific data; determining an optimal response by inputting the user-specific data and the responses into a machine-learning model trained on historical interactions between users and entities; and causing a user interface of a user device to display a visual indication of the optimal response.

### CROSS-REFERENCE TO RELATED APPLICATION(S)

This patent application is a continuation of and claims the benefit of priority to U.S. Nonprovisional patent application Ser. No. 18/630,281, filed on Apr. 9, 2024, the entirety of which is incorporated by reference herein.

### TECHNICAL FIELD

Various embodiments of this disclosure relate generally to correlating responses to user-specific data, and, more particularly, to systems and methods for ranking or determining an optimal response to user-specific data, e.g., using one or more machine-learning techniques.

### BACKGROUND

Interactions that customarily involved an in-person meeting, such as a purchase of a vehicle or property, have been moving towards a more online-focused dynamic. Despite the apparent convenience of online activities, however, moving an interaction online may transfer effort from a provider (e.g., in curating or presenting options) to the user (e.g., in seeking out and comparing options on their own). A user, now having to exert more effort in seeking out providers that can satisfy their need, may have less assurance that they are selecting a best option while seeing little practical gain in convenience. While other interaction models, such as a reverse auction or the like, have been developed, such models generally merely rebalance the factors of effort and assurance to the disadvantage of providers, without addressing any of the underlying technical challenges of moving such interactions online.

This disclosure is directed to addressing challenges such as one or more of the above. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for correlating responses to user-specific data. In an example, an interaction between a user and provider may be facilitated by querying providers using user-specific data, such as prequalification data and interaction data, for responses that include user-specific parameters for the interaction.

In one aspect, a method for correlating responses to user-specific data may include: obtaining user-specific data, wherein the user-specific data includes at least one item parameter set by a user and at least one interaction parameter set by the user; generating a user-specific score for the user based on prequalification data and interaction data of the user; generating a classification of the user from amongst a plurality of possible classifications based on the user-specific score; identifying a plurality of entities providing at least one item that corresponds to the at least one item parameter in the user-specific data; transmitting at least a portion of the user-specific data and the classification of the user to the plurality of entities; receiving a plurality of responses from the plurality of entities, each response including a respective set of parameters for a proposed interaction with the user in which at least one parameter is responsive to the user-specific data; determining an optimal response for the user from amongst the plurality of responses by inputting the user-specific data and the plurality of responses into a trained machine-learning model that has been trained on historical interactions between users and entities; and causing a user interface of a user device associated with the user to display a visual indication of the optimal response.

In another aspect, a computer-implemented method for correlating responses to user-specific data may include: obtaining user-specific data, wherein the user-specific data includes at least one parameter set by a user and a user-specific score based on prequalification data and interaction data of the user; identifying a plurality of entities providing at least one item that corresponds to the at least one parameter in the user-specific data; transmitting at least a portion of the user-specific data to the plurality of entities; receiving a plurality of responses from the plurality of entities, each response including a respective set of parameters for a proposed interaction with the user in which at least one parameter is responsive to the user-specific data; determining an optimal response for the user from amongst the plurality of responses by inputting the user-specific data and the plurality of responses into a trained machine-learning model that has been trained on historical interactions between users and entities; and causing a user interface of a user device associated with the user to display a visual indication of the optimal response.

In a further aspect, a method for correlating responses to user-specific data may include: obtaining user-specific data, wherein the user-specific data includes at least one item parameter set by a user and at least one interaction parameter set by the user; generating a user-specific score for the user based on prequalification data and interaction data of the user; generating a classification of the user from amongst a plurality of possible classifications based on the user-specific score; identifying a plurality of entities providing at least one item that corresponds to the at least one item parameter in the user-specific data; transmitting at least a portion of the user-specific data and the classification of the user to the plurality of entities; receiving a plurality of responses from the plurality of entities, each response including a respective set of parameters for a proposed interaction with the user in which at least one parameter is responsive to the user-specific data; determining a respective match score for each of the plurality of responses with the user-specific data by inputting the user-specific data and the plurality of responses into a trained machine-learning model that has been trained on historical interactions between users and entities, wherein the trained machine-learning model is configured to generate the respective match scores by performing a vector comparison between vector representations of each of the plurality of responses and a further vector representation of the user-specific data; and causing a user interface of a user device associated with the user to display a visual indication that includes at least a portion of the plurality of responses arranged based on a degree of matching between each of the plurality of responses and the user-specific data, and the respective match score for the portion of the plurality of responses.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for correlating responses to user-specific data, according to one or more embodiments.

FIG. 2 depicts a flowchart of an exemplary method of correlating responses to user-specific data, according to one or more embodiments.

FIG. 3 depicts an example of a computing device, according to one or more embodiments.

### DETAILED DESCRIPTION OF EMBODIMENTS

According to certain aspects of the disclosure, methods and systems are disclosed for correlating responses from providers to user-specific data, e.g., querying providers using user-specific prequalification data or user-specific interaction data, and then evaluating or presenting an optimal selection from any response. Conventionally, comparison shopping online involves a user having to seek out and navigate to different providers in order to compare and evaluate their options. Aggregators or reverse auction facilitators operating online may collect options to present to a user, but may be technically limited from enabling providers to make user-specific responses. Moreover, for complex interactions, such as for a purchase of a vehicle or property, technical limitations of online operation may inhibit direct comparison between options.

Accordingly, improvements in technology relating to correlating responses to user-specific data are needed.

As will be discussed in more detail below, in various embodiments, systems and methods are described for using machine learning to evaluate, optimize, or rank responses from providers. By training a machine-learning model, e.g., via supervised or semi-supervised learning, to learn associations between various parameters of an option, the trained machine-learning model may be usable to quantitatively evaluate an option in view of user-specific data.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” or the like generally encompass an entity or person involved in providing, selling, or renting items to persons such as a seller, dealer, renter, merchant, vendor, or the like, as well as an agent or intermediary of such an entity or person. An “item” generally encompasses a good, service, or the like having ownership or other rights that may be transferred. As used herein, terms like “user” or “customer” generally encompasses any person or entity that may desire information, resolution of an issue, purchase of a product, or engage in any other type of interaction with a provider.

As used herein, a “machine-learning model” generally encompasses instructions, data, or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration. By virtue of such training, a machine-learning model is converted from an un-trained and un-specific model to a model that is unique to and specifically configured for the particular purpose for which it is trained. In an example, training of a machine-learning model is analogous to a method of production in which the article produced is the trained model having unique characteristics by virtue of its particular training. Moreover, the result of training a machine-learning model using particular training data and for a particular purpose results in a technical solution to an inherently technical problem.

The execution of the machine-learning model may include deployment of one or more machine learning techniques, such as linear regression, logistical regression, random forest, gradient boosted machine (GBM), deep learning, or a deep neural network. Supervised or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

Conventionally, a user attempting to obtain an item via an online interaction needs to seek out a provider, whereby the provider presents an inventory and parameters for the interaction. A user may make a selection from the inventory to complete the interaction. This conventional flow not only requires that the user expend significant effort in seeking out the provider, but also in evaluating an item against other items in the inventory as well as those offered by other providers. In instances where an item is a complex option, e.g., for a vehicle or property or the like, such evaluation may be impossible or impractical. For example, parameters between options may not match, technical constraints may inhibit direct comparison, and in some cases even reaching an option at a particular provider may be time consuming or may require provider-specific interactions, etc. Moreover, while the user might prefer, in such circumstances, that each provider provides a user-specific option that accounts for not only the user's needs but also the user's circumstances, generally this would require the user separately providing user data to each provider. In interactions for items such as a vehicle or property, such data may include prequalification information, which may be onerous for the user to separately provide to each provider. Further, in many cases, even after expending effort to evaluate options and make a selection, a user may nonetheless remain doubtful whether the selected option was optimal. Moreover, by providing such data to multiple providers, a user may compound the risk of their data being exposed, e.g., due to a data breach, an inadvertent leak, etc.

In an exemplary use case, a user may desire to obtain an item, e.g., a vehicle. For instance, the user may have a desire or preference for one or more parameters or characteristics for a vehicle such as make, model, trim, color, etc. The user may also have a desire or preference for one or more parameters for an interaction to obtain the vehicle, e.g., cost, financing, term, rate, etc. A correlation system may provide an online resource, e.g., a website, portal, application, extension, or the like enabled to receive user-specific data such as the parameters above. In some instances, the correlation system is configured to receive or obtain additional user-specific data such as, for example, prequalification data, identification verification data, past interaction data, credit data, financial or income data, or the like. The correlation system may, in some instances, apply a classification to the user, e.g., based on the user-specific data. For example, the user may be classified based on purchasing power, financial stability, credit rating, likelihood to complete a purchase, etc., or combinations thereof. In some instances, the correlation system may be configured to generate an insight score for the user, e.g., based on the user-specific data. The correlation system may also have access to or records of inventory information for one or more providers, e.g., via periodic update or an ongoing data link.

Upon receipt of the user-specific data, the correlation system may identify one or more providers as having at least one item in inventory that corresponds, e.g., to varying degrees, to one or more parameters of the desired item. In some instances, identified providers are limited or filtered based on additional criteria, such as physical proximity to the user, hours of operation, degree of match of the inventory to the parameters, user-specific preferences, etc. The correlation system may transmit at least a portion of the user-specific data to the one or more providers, e.g., the item parameters or interaction parameters. In some instances, the correlation system may further transmit additional information, such as the classification of the user, a verification of the prequalification information or identification information, or the like. In some instances, the transmission is provided via an online resource, e.g., a portal, website, application, communication stream, or the like accessible by the providers. In some instances, the user-specific data is provided or made available to the providers at or near the same time. In some instances, the user-specific data is provided in order of provider having potentially best matching inventory, physical proximity to the user, or based on other criteria such as one or more parameters for the interaction. In an example, a parameter for the interaction may include that the correlation system or an associated system or entity be selected as the technical infrastructure for executing at least a portion of the interaction.

A provider, e.g., upon receipt of the user-specific data, may generate a response that includes one or more parameters for an interaction with the user, e.g., to provide one or more matching items, that is responsive to the user-specific data. In some instances, the provider may select one or more items from their inventory to include in the response. In some instances, the correlation system identifies, for the provider, one or more matching items from the provider's inventory. In some instances, the provider or correlation system includes or accesses an automated selection algorithm to select one or more items from their inventory. Along with one or more items from inventory, a response may include parameters for the interaction with the user. For example, the provider may evaluate the received user-specific data or enter one or more parameters for the interaction e.g., via the online resource. In some instances, the online resource may be configured to apply one or more predetermined rules to the user-specific data in order to initialize, limit, or set at least a portion of the one or more interaction parameters. In an example, a classification of the user included in or with the user-specific data may be used to initialize, limit, or set one or more of the parameters for the interaction. In another example, the classification may be used to generate a notification or parameter recommendation for the provider. In some instances, the response includes one or more images of the matching item(s), information regarding the provider such as physical location, hours, or the like. The providers, e.g., via the online resource, may transmit the generated response to the correlation system.

In some instances, the correlation system may define a predetermined time window for accepting responses. In some instances, the correlation system may evaluate the received responses. Evaluation may include, for example, determining an optimal response in view of the user-specific data, or ranking the responses in terms of similarity to the user-specific interaction and item parameters, financial information of the user, proximity or availability of the provider to the user, etc. In some instances, the correlation system may employ a machine-learning model for evaluating the responses. In an example, a support vector machine, clustering model, or the like, may be used to evaluate similarity between responses and the user-specific data. In some instances, a machine learning model may be employed to learn associations between historical user-specific data, such as historical user-specific interaction parameters, user financial information, etc., and interaction parameters that were applied in historical interactions that were completed. As used herein, an interaction being “completed” generally encompasses where a primary intention of the interaction is fulfilled, e.g., ownership of a vehicle or property is transferred. In comparison, an interaction that was not completed may include where a user browsed or negotiated for an item, but ultimately did not proceed to transfer ownership.

The correlation system may provide one or more of the responses to the user, e.g., via the online resource. The correlation system may, for example, select a sub-set of the responses to provide based on the evaluation, or may display a visual indication of the evaluation such as a similarity score, recommendation, or the like.

In some instances, information associated with responses from one or more providers may be shared with one or more other providers. For example, during the predetermined time window during which responses are accepted, providers may be able to view a similarity score for their response, a relative ranking of their response compared to other responses, or details about other responses. Providers may be able to update their response, e.g., via the online resource. In some instances, the responses are only provided to the user once they are final, e.g., after an expiration of the predetermined time window, after a provider indicates a response is final, or after the user or other entity enters an indication to close the availability of accepting responses. In some instances, the correlation system may provide progress information to the user, e.g., a number of providers in receipt of the user-specific data or that have submitted a response, a time left in the predetermined time window, or the like.

The one or more responses provided to the user, e.g., via the online resource, may be selectable by the user, and configured to initiate, e.g., via the correlation system, the provider, or another system, an interaction with the provider for the selected response. In some instances, the one or more responses may be editable, e.g., so that a user may propose a modification that is transmitted back to the corresponding provider for approval. In some instances, the acceptance of a response option by the user causes the correlation system to provide additional information to the corresponding provider, such as user identification information or user contact information, financial information, payment information, etc. In some instances, the correlation system or another system is configured to act as an intermediary to process the interaction. In some instances, acceptance of a response option is configured to cause the provider to reserve the corresponding item from their inventory, such that the reserved item is no longer available for other interactions, or propose or schedule an in-person visit for continuing or completing the interaction with the provider.

While several of the examples above involve an interaction to obtain a vehicle, it should be understood that techniques according to this disclosure may be adapted to any suitable type of item such as, for example, a property, a loan, a rental, an equity, a service, etc. It should also be understood that the examples above are illustrative only. The techniques and technologies of this disclosure may be adapted to any suitable activity.

Presented below are various aspects of machine learning techniques that may be adapted to correlating responses from providers to user-specific data. As will be discussed in more detail below, machine learning techniques adapted to correlating responses, may include one or more aspects according to this disclosure, e.g., a particular selection of training data, a particular training process for the machine-learning model, operation of a particular device suitable for use with the trained machine-learning model, operation of the machine-learning model in conjunction with particular data, modification of such particular data by the machine-learning model, etc., or other aspects that may be apparent to one of ordinary skill in the art based on this disclosure.

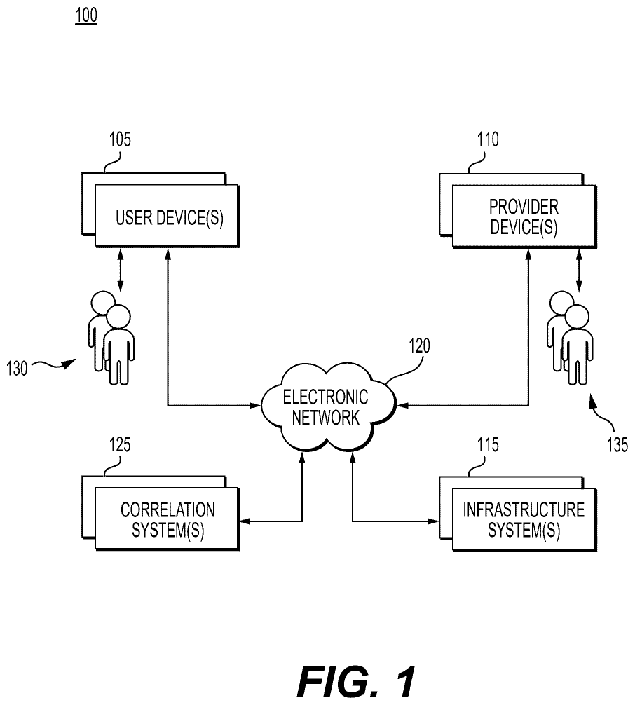

FIG. 1 depicts an exemplary environment 100 that may be utilized with techniques presented herein. One or more user device(s) 105, one or more provider system(s) 110, or one or more infrastructure system(s) 115 may communicate across an electronic network 120. As will be discussed in further detail below, one or more correlation system(s) 125 may communicate with one or more of the other components of the environment 100 across electronic network 120. The one or more user device(s) 105 may be associated with a user 130, e.g., a user associated with one or more of researching, browsing, prequalifying for, or obtaining an item or other related goods or services. The one or more provider system(s) 110 may be associated with a provider 135, e.g., a person or entity with whom a user 130 may interact with in regard to an item. Various persons or entities (not shown) may be associated with the infrastructure system(s) 115 or correlation system(s) 125, e.g., in generating, training, or tuning a machine-learning model for correlating response data, generating, obtaining, or analyzing evaluations of response data, e.g., using a trained model, or providing related data or analysis.

In some embodiments, the components of the environment 100 are associated with a common entity, e.g., a financial institution, transaction processor, merchant, or the like. For example, the correlation system 125 and the infrastructure system 115 may be associated with a lender or item aggregator. In some embodiments, one or more of the components of the environment are associated with a different entity than another. The systems and devices of the environment 100 may communicate in any arrangement.

The user device 105 may be configured to enable the user 130 to access or interact with other systems in the environment 100. For example, the user device 105 may be a computer system such as, for example, a desktop computer, a mobile device, a tablet, etc. In some embodiments, the user device 105 may include one or more electronic application(s), e.g., a program, plugin, browser extension, etc., installed on a memory of the user device 105. In some embodiments, the electronic application(s) may be associated with one or more of the other components in the environment 100. For instance, the electronic application(s) may be associated with or configured to communicate with the correlation system 125 or the infrastructure system 115. In an example, the electronic application may include a client-side instance or a portal that operates in conjunction with a server-side instance that may be hosted by the correlation system 125, the infrastructure system 115, or the like.

The provider system 110 may be configured to access or interact with other systems in the environment 100. For example, the provider system 110 may be a computer system such as, for example, a desktop computer, a mobile device, a tablet, etc. In some embodiments, the provider system 110 may include one or more electronic application(s), e.g., a program, plugin, browser extension, etc., installed on a memory of the provider system 110. For example, the electronic application may include a client-side instance or a portal that operates in conjunction with a server-side instance that may be hosted by the correlation system 125, the infrastructure system 115, or the like. In some instances, the electronic application on the provider system 110 may include or be configured to operate in conjunction with a program or tool for one or more of managing inventory for the provider 135, facilitating interactions between the provider 135 and users 130, e.g., via an infrastructure system 115 as discussed in further detail below. In some embodiments, the provider system 110 may include a server system, an electronic data system, or computer-readable memory such as a hard drive, flash drive, disk, etc. In some embodiments, the provider system 110 includes or interacts with an application programming interface for exchanging data to other systems, e.g., one or more of the other components of the environment. The provider system 110 may include or act as a repository or source for inventory data, interaction data, or the like. In an example, a provider system 110 may include a database, e.g., a relational database, which indexes items along with various parameters for those items. For example, an inventory database may list a respective entry for each item in the inventory, whereby each entry includes information regarding the parameters for that item. In some embodiments, the provider system 110 may store additional data such as, for example, location or address data for the provider 135 or the inventory, or one or more parameters, limits, or criteria regarding interactions for the inventory. For example, a provider system 110 may relate interaction parameters or limits or criteria for the same, such as price, down payment, financing, etc., to inventory items. In other words, the provider system 110 may store or track provider-specific criteria for item interactions for its inventory.

The infrastructure system 115 may be associated with, for example, a financial institution such as a lender, payment processor, credit rating entity, user financial account provider, etc. The infrastructure system 115 may include a server system, an electronic data system, or computer-readable memory such as a hard drive, flash drive, disk, etc. In some embodiments, the infrastructure system 115 includes or interacts with an application programming interface for exchanging data to other systems, e.g., one or more of the other components of the environment. The infrastructure system 115 may include or act as a repository or source for interaction data, financial data, credit data, user data, etc. For example, the infrastructure system 115 may aggregate or store user-specific data for one or more users 130 such as historical transaction data, historical income data, credit rating data or data usable to generate the same, financial position or stability data or data usable to generate the same, demographic information, address information, identification or identification verification information, or one or more interaction parameters or limits or criteria therefore. In an example, the infrastructure system 115 may generate qualifications for users 130 based on user-specific information, e.g., a prequalification status or the like, and may store prequalification status data or data usable to generate the same. In an example, the infrastructure system may facilitate or provide financing options for users 130 such as a loan, underwriting, or the like, and may store financing information or data usable to generate the same.

In various embodiments, the electronic network 120 may be a wide area network (“WAN”), a local area network (“LAN”), personal area network (“PAN”), or the like. In some embodiments, electronic network 120 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like.

As discussed in further detail below, the correlation system 125 may one or more of generate, store, train, or use a machine-learning model configured to correlate or evaluate responses, e.g., from provider system(s) 110, based on user-specific data. The correlation system 125 may include a machine-learning model or instructions associated with the machine-learning model, e.g., instructions for generating a machine-learning model, training the machine-learning model, using the machine-learning model, etc. The correlation system 125 may include instructions for retrieving user-specific data, response data, etc., adjusting or evaluating such data, e.g., based on the output of the machine-learning model, or causing one or more devices to display information based on the output from the machine-learning model. The correlation system 125 may include training data, e.g., historical user interaction data, historical inventory data, historical user financial data, etc.

In some embodiments, a system or device other than the correlation system 125 is used to generate or train the machine-learning model. For example, such a system may include instructions for generating the machine-learning model, the training data and ground truth, or instructions for training the machine-learning model. A resulting trained-machine-learning model may then be provided to the correlation system 125.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training or used to validate the trained machine-learning model, e.g., compare the output of the trained model with the ground truth for that portion of the training data to evaluate an accuracy of the trained model. The training of the machine-learning model may be configured to cause the machine-learning model to learn associations between user-specific data and response data, such that the trained machine-learning model is configured to evaluate (e.g., rank, compare, optimize, etc.) responses based on input of user-specific data.

Although depicted as separate components in FIG. 1, it should be understood that a component or portion of a component in the environment 100 may, in some embodiments, be integrated with or incorporated into one or more other components. For example, a portion of the infrastructure system 115 may be integrated into the correlation system 125 or the like. In another example, the correlation system 125 or the infrastructure system 115 may be integrated into the provider system 110. In some embodiments, operations or aspects of one or more of the components discussed above may be distributed amongst one or more other components. Any suitable arrangement or integration of the various systems and devices of the environment 100 may be used.

Further aspects of the machine-learning model or how it may be utilized in relation to various aspects of this disclosure are discussed in further detail in the methods below. In the following methods, various acts may be described as performed or executed by a component from FIG. 1, such as the correlation system 125, the user device 105, the provider system 110, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, or rearranged in any suitable manner.

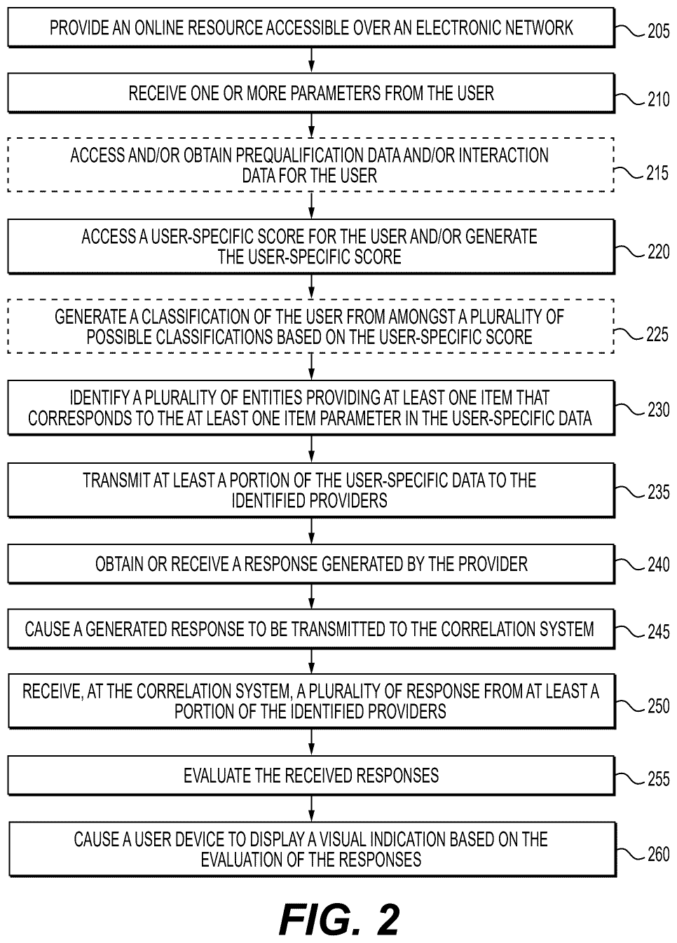

FIG. 2 illustrates an exemplary process for correlating responses to user-specific data, such as in the various examples discussed above. A user 130 may desire to obtain an item for which a prequalification is needed before it may be obtained, e.g., a vehicle, a real estate property, etc. The user 130 may, e.g., via a user device 105, register for and submit information associated with a prequalification status with an infrastructure system 115 or the like. For instance, the user 130 may communicate with a lender, credit rating entity, or the like in order to request a status such as qualified purchaser, or the like. The infrastructure system 115 may request user-specific information, such as identification information, financial information, income information, address information, demographic information, etc. The infrastructure system 115 may apply one or more verification process to submitted user-specific information and, upon such information being verified, may generate a prequalification status or the like for the user 130.

The user 130, in seeking the item, may have in mind one or more parameters for the item, e.g., for a vehicle: make, model, year, color, efficiency, features, add-ons, etc. Similarly, providers 135 may have respective inventories of items and may track, e.g., via a provider system 110, data for the inventory such as by a database that lists various items along with various parameters for those items. The user 130 may additionally have in mind one or more parameters for the interaction, e.g., for a vehicle: cost, financing amount or rate, term, payment frequency or amount, down payment, insurance, etc. Similarly, providers 135 or entities associated with an infrastructure system 115 may have respective parameters or limits or criteria therefore.

At step 205, the correlation system 125 may provide an online resource accessible over the electronic network 120. For example, the correlation system 125 may provide one or more of a portal, app, website or the like. In some embodiments, a communication link may be provided between one or more providers 135, e.g., via a provider system 110, and the online resource. For instance, the provider 135, via the communication link, may provide data regarding items in stock in their inventory, location data for the provider 135, etc. In some embodiments, a communication link may be provided between one or more infrastructure system 115 and the online resource. For instance, the infrastructure system 115, via the communication link, may provide user-specific data such as prequalification information, financial information, identification information or identification verification information, or the like.

At step 210, the online resource may receive one or more parameters from the user 130. For example, the user 130 may access the online resource, e.g., via the user device 105, and provide one or more parameters for the desired item or one or more parameters for the interaction to obtain the desired item. For example, the online resource may include a Graphical User Interface (GUI) configured to receive various parameters from the user 130. In some embodiments, the GUI may be configured to enable a user 130 to select which parameters to include in a submission. In some embodiments, the GUI may be configured to receive user-set rankings or weights for the parameters that are indicative of a relative importance of the parameters to the user 130. In some embodiments, a user not entering a value for a parameter is treated as if the user set the parameter to a default or null value.

Optionally, at step 215, the correlation system 125 may access or obtain prequalification data or interaction data for the user 130, e.g., from the infrastructure system 115 or the like. The prequalification data may include a prequalification status of the user 130 or one or more limits or criteria for one or more parameters of the interaction to obtain the item for the user 130. For example, the prequalification data may indicate that the user 130 has prequalification status for any obtainment of an item up to a threshold cost, or for up to a threshold monthly amount, etc. The interaction data may include, for example, any historical interactions of the user 130 to obtain similar items, e.g., whether they were completed or not, what type of items they were, when the interactions occurred, whether the user 130 adhered to interaction parameters such as timely payments, etc.

At step 220, the correlation system 125 may access a user-specific score for the user 130 or generate the user-specific score, e.g., based on the prequalification data and interaction data. In an example, the user-specific score may include a “soft-pull” credit rating for the user 130, e.g., that relies on data from the prequalification data rather than requiring a hard credit data pull for the user 130. In some embodiments, the user-specific score is indicative of a factor instead of or in addition to a credit rating such as, for example, preparedness or urgency to complete an interaction, willingness to haggle, permissiveness to flexibility in provided parameters, etc. In an example, such factors may be determined via application of one or more criteria or algorithms to the user-specific interaction data. For instance, a machine-learning model may be trained to identify, from historical interactions of a user 130, a range for one or more parameters that the user 130 may be willing to negotiate, a prediction regarding a timeline for the user 130 to complete an interaction, and may generate conclusions, predictions, or inferences for one or more of the factors above based thereon.

Optionally, at step 225, in some embodiments, the correlation system 125 may generate a classification of the user 130 from amongst a plurality of possible classifications based on the user-specific score. For example, the correlation system 125 may classify the user 130 as one or more of a motivated buyer, a difficult haggler, an individual with a risky financial position, a verified identity, a verified prequalified buyer, etc. In various embodiments, the classification may be based on, for example, the user-specific score, the prequalification data, or the interaction data. In some embodiments, the correlation system 125 may access other information of the user 130 to make a classification, e.g., financial information, income information, transaction history, credit rating data, demographic data, etc. In some embodiments, the classification is performed by comparing user-specific data to other pre-classified user, clusters of pre-classified users, pre-generated data for a model user for different classifications, based on predetermined criteria, etc.

At step 230, the correlation system 125 may identify a plurality of entities, e.g., providers 135, providing at least one item that corresponds to the at least one item parameter in the user-specific data. In one embodiment, the correlation system 125 may compare the one or more item parameters set by the user with item parameters of items in the inventory of one or more providers 135. In one embodiment, the correlation system 125 may access or generate an aggregate database that includes information sourced from the inventory databases of the providers, and may execute a search query on the aggregate database. In one embodiment, one or more providers 135 may provide to the correlation system 125 one or more item parameters or types of parameters for items in their inventory. For instance, a provider 135 may indicate to the correlation system 125 that their inventory includes items with a particular parameter value, items with parameter values within a certain range or selected from certain options, etc. In some embodiments, providers 135 may be filtered, e.g., prior to or during the identifying, based on whether the providers 135 are within a predetermined geographical distance from a location associated with the user 130. In various embodiments, the predetermined geographical distance may be set by the user 130, the provider 135, or any other suitable entity.

At step 235, the correlation system 125 may transmit at least a portion of the user-specific data to the identified providers 135, e.g., via the corresponding provider systems 110. For example, in various embodiments, the correlation system 125 may transmit to the identified providers 135 one or more of the user-set item parameters, the user-set interaction parameters, the prequalification data, the user-specific score, the classification of the user 130, or the like. In some embodiments, the sending of the transmission tolls the beginning of a predetermined time window for receiving responses, as discussed in further detail below.

In some embodiments, the transmission is made via an online resource available to the providers 135. For instance, the correlation system 125 may provide or operate in conjunction with a portal, website, app, or the like that providers 135 may access, e.g., via a provider system 110, in order to receive or evaluate incoming user-specific data. In some embodiments, the transmission from the correlation system 125 may be configured to cause the online resource for the provider 135 to generate a visual display of the received information.

In some embodiments, the provider system 110 may include an at least partially automated system for receiving and evaluating incoming customer-specific data. For example, the provider system 110 may include provider-set item or interaction parameters for an item. The provider system 110, upon receipt of user-specific data, may compare user-set parameters with the provider-set parameters for a matching item. The provider system 110 may be configured to take one or more actions based on the comparison, e.g., one or more of the provider actions discussed in further detail below.

In some embodiments, such configuration may be based on predetermined criteria set by the provider 135.

In some embodiments, the transmission includes an identification of one or more items in the provider 135's inventory that match at least one of the user-set item parameters. In some embodiments, the provider system 110, e.g., via the online resource, is configured to automatically identify the one or more matching items. In some embodiments, the provider system 110, e.g., via the online resource, is configured to receive identifications of matching items from the provider 135. For example, in some embodiments, the online resource is configured to communicate with an inventory database of the provider system 110. In some embodiments, the online resource includes a GUI configured to receive identifications of matching items or parameters for the items or interactions for obtaining such items by the user 130.

In some embodiments, the transmission is made to all of the identified providers 135 in common, e.g., in parallel at the same or nearly the same time. In some embodiments, the timing for transmission to one or more sub-sets of identified providers 135 may be different. For example, a portion of the providers 135 may be indicated as higher in priority than others. In an example, one or more providers 135 may have a predetermined association or status with the correlation system 125 or an infrastructure system 115 that is associated with the higher priority. In another example, priority may be assigned based on physical proximity of the providers 135 to a location associated with the user 130. In a further example, priority may be based on regency of an interaction with the provider 135 facilitated by the correlation system 125. A lower priority may result in delay of transmission by a period of time, e.g., one minute, ten minutes, an hour, etc., or by a portion or percentage of the predetermined time window, e.g., 10%, 25%, 50%, etc.

At step 240, the online resource may obtain or receive a response generated by the provider. For example, the provider 135 may generate a response to the user-specific data. For example, the provider 135, using the online resource via the provider system 110, may generate a response by entering, identifying, selecting, designating, or the like information regarding an identification of an item in inventory, one or more item parameters of the item, one or more parameters of an interaction to obtain the item, etc. The provider 135 may base at least a portion of the generated response on the user-specific data. For example, the transmission from step 235 may include various elements of user-specific data usable to evaluate one or more parameters included in the response.

In some embodiments, the online resource may be configured to pre-set or recommend one or more values or limits for values for one or more parameters based on the received user-specific data. For example, the online resource may be configured to set a value or limit for a down-payment parameter based on the user-specific score of the user 130.

In some embodiments, the online resource may be configured to enable the provider 135 to directly compare user-specific data from different users. For example, in some embodiments, the online resource, e.g., in conjunction with the correlation system 125 may display visual indications of user-specific data from a plurality of users 130. The visual indication may include one or more parameters of the user-specific information or may include one or more comparative visualizations. Examples of a comparative visualization may include, for example, visual identifiers associated with one or more classifications of the users 130, the user-specific score for the users 130, highlights, coloring, or any other suitable accent for a parameter for a user 130 relative to another user 130, etc. For instance, one user 130 may have included a proposed price as an interaction parameter that is higher than a proposed price from a different user 130 for a same or similar item. In another instance, a visual indication for a user 130 with a high user-specific score may include a colored border or the like to identify the user 130 as a motivated buyer, a buyer with secure financing, etc.

In some embodiments, the online resource may be configured to identify or arrange the visual indications based on a determination that the item(s) in the provider 135's inventory matched to each user 130's user-specific data overlap. For example, in some embodiments, the online resource may group all visual indications together that match with at least one item in the inventory in common. In this manner, a provider 135 may readily identify or select between different users 130 for whom to generate a response.

As noted above, generating the response may include setting one or more parameters for an item or interaction to obtain the item. For example, the GUI of the online resource may enable a provider 135 to make changes to user-set parameters (e.g., replace a color value with another, change a purchase price, down payment amount, etc.), or set values to default or null value parameters (e.g., add in a model year for a blank model year parameter, include an add-in into an offer, etc.). In another example, a user-set parameter may include a trade-in value for a previous item, and the provider may adjust the trade-in value. In a further example, a user-set parameter may identify a previous item as available, may include one or more parameters for the previous item, and the provider 135 may set a parameter for trade-in value. In some embodiments, the GUI is configured to visually indicate any variance between the user-set parameters and the provider-set parameters, e.g., via a text notification, coloration, highlight, or the like.

At step 245, the provider 135 may cause a generated response to be transmitted to the correlation system 125.

At step 250, the correlation system 125 may receive a plurality of response from at least a portion of the identified providers 135, e.g., via the online resource. In some embodiments, the correlation system 125 is configured to only accept responses received prior to expiration of the predetermined time window. In some embodiments, responses are evaluated, as discussed in further detail below, continuously as they are received. In some embodiments, the correlation system 125 waits to evaluate any responses until expiration of the predetermined time window. In an example, a correlation system 125 may be configured to wait until expiration of the predetermined time window to evaluate any responses, but then may be configured to continuously evaluate further responses as they are received after the predetermined window has expired. In some embodiments, instead of or in addition to the predetermined time window, the correlation system 125 waits to evaluate any response until at least a threshold number of responses have been received.

In various embodiments, the predetermined time window may be set by the correlation system 125, the user 130, or another entity. In some embodiments, the predetermined time window is a recommendation from the correlation system 125, e.g., that the user 130 may select via the GUI of the online resource to cancel, ignore, or extend.

In some embodiments, the online resource may be configured to enable one or more providers 135 to view generated responses from other provides 135. For example, before, during, or after generating a response, a provider 135 may be able to view at least a portion of information for a response generated by another provider 135. In some embodiments, the online resource may generate a visual indication of a variance between the other provider 135's response and one or more of the user-specific data or the provider's response. In some embodiments, the online resource may be configured to enable providers 135 to adjust one or more parameters of their response after the response is generated. Such adjustments may be propagated to, for example, other providers 135 accessing the online resource, the correlation system 125, or to the user 130.

At step 255, the correlation system 125 may evaluate the received responses. In some embodiments, the evaluation includes determining an optimal response for the user 130, e.g., a response that is a closest match to the user-set parameters or that provides a best value to the user. In some embodiments, the evaluation includes determining relative ranks for the responses, e.g., based on a matching similarity between the responses and the user-set parameters. In some embodiments, the evaluation includes determining a respective match score each of the plurality of responses with the user-specific data. In an example, the match score may be based on a vector comparison between vector representations of each of the plurality of responses and a further vector representation of the user-specific data, as discussed in further detail below.

Any suitable evaluation technique may be used. In an example, the evaluation includes inputting the user-specific data and the plurality of responses into a trained machine-learning model that has been trained on historical interactions between users and entities. For instance, parameter values may be used to represent the responses and the user-specific data as vectors, which may be input into the trained machine-learning model, e.g., a support vector machine, a clustering machine that performs a nearest neighbor analysis, or any other suitable type of machine-learning model. In some embodiments, the trained machine-learning model may be configured to determine factors such as affordability of an offer for the user 130, e.g., based on the user 130's financial information.

In some embodiments, the trained machine-learning model is configured to apply preferences or relative importances for one or more parameters when performing the evaluation. For instance, if a user-set parameter is very different from a provider-set parameter for which the user 130 has set a relatively low importance compared to other parameters, that difference may be weighted lower than other comparisons of parameters by the trained model. Further aspects of the training for the trained model are discussed in further detail below.

At step 260, the correlation system 125 may cause the user device 105, e.g., via the GUI of the online resource for the user 130, to display a visual indication based on the evaluation of the responses. In some embodiments, the visual indication identifies an optimal response, e.g., a response from the plurality of responses having a highest match score, a highest value to the user 130, or the like. In some embodiments, the visual indication includes the match score for the optimal response. In some embodiments, the visual indication includes at least a portion of the plurality of responses. For example, multiple responses may be displayed, arranged based on a degree of matching between each of the plurality of responses and the user-specific data. In some embodiments, the visual indication may include the match scores for all of the displayed responses.

In some embodiments, the visual indication for each displayed response includes a selectable interactive element operable to initiate an interaction or communication with the provider 135 corresponding to a selected response. For example, in some embodiments, selection of a particular response may cause one or more of a scheduling of a visit of the user 130 to the provider 135, a reservation by the provider 135 for the item included in the response (e.g., such that the item is no longer available for inclusion in other responses by the provider 135), an initiation of an interaction, e.g., via the infrastructure system 115, for the user 130 to obtain the item, etc.

As noted above, in some instances, a provider 135 may enter an adjustment to their response. In some embodiments, such adjustment may cause the correlation system 125 to re-evaluate the response. For example, the adjustment may result in a change to the match score for the response, a relative ranking of the responses, or the visual indication output to the user via the GUI of the online resource. In an exemplary use case, a user 130 may, via the GUI of the online resource, be able to view dynamic activity of several providers 135 adjusting their responses in competition with each other. The user 130, e.g., based on their view of the activity of the providers 135, may decide to set, reduce, extend, or close a window for receiving responses or adjustments to responses. In some embodiments, responses or adjustments from the providers 135 are not provided to the user 130 until expiration of the time window. In some embodiments, the user 130 may selectively freeze or unfreeze responses from being adjusted, e.g., at expiration of the time window or on selection of a particular response.

As noted above, the trained machine-learning model may have been trained on historical interactions between users and entities. In an example, a machine-learning model may be undergo supervised training based on historical user-set parameters, corresponding historical responses from providers, or historical interaction records in order to learn, for example, associations between user-set parameters and response that were ultimately selected or completed by historical users. In another example, unsupervised training may be used to cluster historical records together, e.g., user-set parameter and response pairs that did or did not result in a completed interaction to obtain an item, whereby identifying how closely input for the user-specific data and a respective response matches the cluster for historical data for which an interaction was completed is indicative of degree of matching for the input data. Any suitable training technique may be used.

It should be understood that embodiments in this disclosure are exemplary only, and that other embodiments may include various combinations of features from other embodiments, as well as additional or fewer features. For example, while some of the embodiments above pertain to interactions to obtain a vehicle, any suitable activity may be used.

In general, any process or operation discussed in this disclosure that is understood to be computer-implementable, such as the processes illustrated in FIG. 2, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

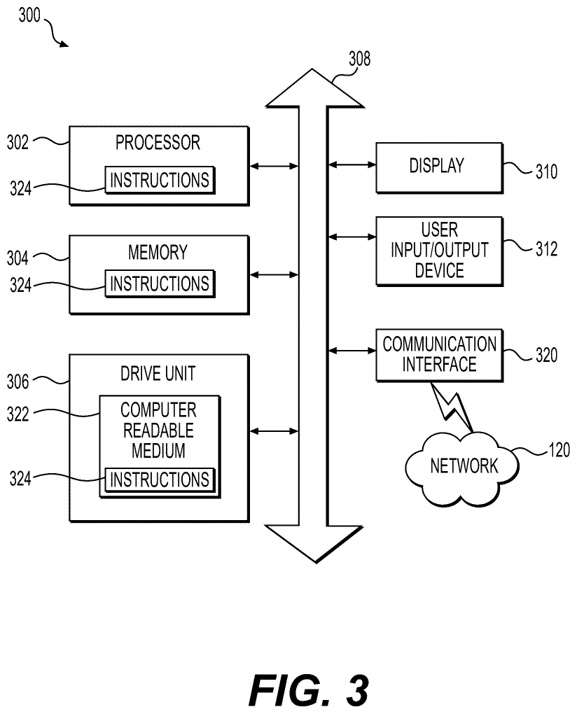

FIG. 3 is a simplified functional block diagram of a computer 300 that may be configured as a device for executing the methods of FIGS. 2 and 3, according to exemplary embodiments of the present disclosure. For example, the computer 300 may be configured as the correlation system 125 or another system according to exemplary embodiments of this disclosure. In various embodiments, any of the systems herein may be a computer 300 including, for example, a data communication interface 320 for packet data communication. The computer 300 also may include a central processing unit (“CPU”) 302, in the form of one or more processors, for executing program instructions. The computer 300 may include an internal communication bus 308, and a storage unit 306 (such as ROM, HDD, SDD, etc.) that may store data on a computer readable medium 322, although the computer 300 may receive programming and data via network communications. The computer 300 may also have a memory 304 (such as RAM) storing instructions 324 for executing techniques presented herein, although the instructions 324 may be stored temporarily or permanently within other modules of computer 300 (e.g., processor 302 or computer readable medium 322). The computer 300 also may include input and output ports 312 or a display 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for correlating reverse-auction bids for a product to user-specific data, comprising:
obtaining user-specific data for one or more users, wherein the user-specific data includes, in each case, at least one product parameter set by a user and at least one purchase parameter set by the user;
generating a user-specific score for each user based on credit prequalification data and historical purchase data of the user;
generating a classification of each user from amongst a plurality of possible classifications based on the user-specific score;
generating a respective visual indication associated with each user, each visual indication including one or more of:
a visual element indicative of one or more parameter from the user-specific data for the user;
a visual element indicative of the classification or user-specific score of the user; or
a visual element indicative of a comparison between one or more parameter from the user-specific data for the user and one or more parameter from the user-specific data for one or more other users;
in response to access of a portal by one or more providers via an electronic network:
determining, for each provider, a subset of the one or more users for which at least one product parameter in the user-specific data corresponds to at least one product provided by the provider; and
causing the portal to output, to each provider, at least a portion of the respective visual indications corresponding to the subset of users.

2. The computer-implemented method of claim 1, further comprising:
receiving at least one reverse-auction bid from at least one of the one or more providers via the portal, the at least one reverse-auction bid identifying a respective one of the one or more users.

3. The computer-implemented method of claim 2, wherein:
a plurality of reverse-auction bids are received for the respective visual indication associated with a user;
the computer-implemented method further comprises:
determining an optimal reverse-auction bid for the user from amongst the plurality of reverse-auction bids by inputting the user-specific data for the user and the plurality of reverse-auction bids into a trained machine-learning model that has been trained on historical purchases by various users at various vendors; and
causing a user interface of a user device associated with the user to display a visual indication of the optimal reverse-auction bid.

4. The computer-implemented method of claim 2, further comprising:
in response to receiving the at least one reverse-auction bid from the at least one provider, causing the portal to output an indication of one or more parameters of the at least one reverse-auction bid to at least one other provider.

5. The computer-implemented method of claim 2, further comprising:
receiving a response from the user corresponding to the at least one reverse-auction bid; and
updating the respective visual indication based on the response.

6. The computer-implemented method of claim 1, wherein the portal is configured to limit an extent of time for which each visual indication is accessible to the one or more providers.

7. The computer-implemented method of claim 1, wherein the respective visual indications on the portal are selectable User Interface (UI) elements that are selectable by the one or more providers to enter a reverse-auction bid.

8. The computer-implemented method of claim 7, wherein the UI elements are configured to enable a provider to edit one or more parameters of the user-specific data corresponding to the respective visual indication for entering the reverse-auction bid.

9. The computer-implemented method of claim 1, wherein the visual element includes one or more of a coloration, a border, a highlight, an accent, or a comparison.

10. The computer-implemented method of claim 1, wherein the output of the respective visual indications is visually arranged into one or more groups based on a similarity between one or more parameters.

11. A computer-implemented method for correlating reverse-auction bids for a product to user-specific data, comprising:
obtaining user-specific data for one or more users, wherein the user-specific data includes, in each case, at least one product parameter set by a user and a user-specific score based on credit prequalification data and historical purchase data of the user;
generating a respective visual indication associated with each user, each visual indication including one or more of:
a visual element indicative of one or more parameter from the user-specific data for the user;
a visual element indicative of the user-specific score of the user; or
a visual element indicative of a comparison between one or more parameter from the user-specific data for the user and one or more parameter from the user-specific data for one or more other users;
in response to access of a portal by one or more providers via an electronic network:
determining, for each provider, a subset of the one or more users for which at least one product parameter in the user-specific data corresponds to at least one product provided by the provider; and
causing the portal to output, to each provider, at least a portion of the respective visual indications corresponding to the subset of users.

12. The computer-implemented method of claim 11, further comprising:
receiving at least one reverse-auction bid from at least one of the one or more providers via the portal, the at least one reverse-auction bid identifying a respective one of the one or more users.

13. The computer-implemented method of claim 12, wherein:
a plurality of reverse-auction bids are received for the respective visual indication associated with a user;
the computer-implemented method further comprises:
determining an optimal reverse-auction bid for the user from amongst the plurality of reverse-auction bids by inputting the user-specific data for the user and the plurality of reverse-auction bids into a trained machine-learning model that has been trained on historical purchases by various users at various vendors; and
causing a user interface of a user device associated with the user to display a visual indication of the optimal reverse-auction bid.

14. The computer-implemented method of claim 12, further comprising:
in response to receiving the at least one reverse-auction bid from the at least one provider, causing the portal to output an indication of one or more parameters of the at least one reverse-auction bid to at least one other provider.

15. The computer-implemented method of claim 12, further comprising:
receiving a response from the user corresponding to the at least one reverse-auction bid; and
updating the respective visual indication based on the response.

16. The computer-implemented method of claim 11, wherein:
the respective visual indications on the portal are selectable User Interface (UI) elements that are selectable by the one or more providers to enter a reverse-auction bid; and
the UI elements are configured to enable a provider to edit one or more parameters of the user-specific data corresponding to the respective visual indication for entering the reverse-auction bid.

17. The computer-implemented method of claim 11, wherein the visual element includes one or more of a coloration, a border, a highlight, an accent, or a comparison.

18. The computer-implemented method of claim 11, wherein the output of the respective visual indications is visually arranged into one or more groups based on a similarity between one or more parameters.

19. A computer-implemented method for correlating reverse-auction bids for a product to user-specific data, comprising:
obtaining user-specific data for one or more users, wherein the user-specific data includes, in each case, at least one product parameter set by a user and at least one purchase parameter set by the user;
generating a user-specific score for each user based on credit prequalification data and historical purchase data of the user;
generating a classification of each user from amongst a plurality of possible classifications based on the user-specific score;
generating a respective visual indication associated with each user, each visual indication including one or more of:
a visual element indicative of one or more parameter from the user-specific data for the user;
a visual element indicative of the classification or user-specific score of the user; or
a visual element indicative of a comparison between one or more parameter from the user-specific data for the user and one or more parameter from the user-specific data for one or more other users;
in response to access of a portal by one or more providers via an electronic network:
determining, for each provider, a subset of the one or more users for which at least one product parameter in the user-specific data corresponds to at least one product provided by the provider; and
causing the portal to output, to each provider, at least a portion of the respective visual indications corresponding to the subset of users, wherein:
the respective visual indications on the portal are selectable User Interface (UI) elements that are selectable by the one or more providers to enter a reverse-auction bid; and
the UI elements are configured to enable a provider to edit one or more parameters of the user-specific data corresponding to the respective visual indication for entering the reverse-auction bid; and
receiving, via the portal, a plurality of reverse-auction bids from the one or more providers for the respective visual indication associated with a user;
determining an optimal reverse-auction bid for the user from amongst the plurality of reverse-auction bids by inputting the user-specific data for the user and the plurality of reverse-auction bids into a trained machine-learning model that has been trained on historical purchases by various users at various vendors; and
causing a user interface of a user device associated with the user to display a visual indication of the optimal reverse-auction bid.

20. The computer-implemented method of claim 19, further comprising:
in response to receiving the at least one reverse-auction bid from the at least one provider, causing the portal to output an indication of one or more parameters of the at least one reverse-auction bid to at least one other provider, wherein the portal is configured to limit an extent of time for which each visual indication is accessible to the one or more providers.
